(19) United States
(12) Patent Application Publication
(10) Pub. No.: US 2005/0286382 A1
(43) Pub. Date: Dec. 29, 2005

(54) Optical disk apparatus and control program for the same

(76) Inventor: Hiroshi Okamoto, Ueda-shi (JP)

Correspondence Address: BIRCH STEWART KOLASCH & BIRCH, PO BOX 747, FALLS CHURCH, VA, 22040-0747, US

(21) Appl. No.: 11/166,117

(22) Filed: Jun. 27, 2005

(30) Foreign Application Priority Data
Jun. 28, 2004 (JP) 2004-189614

(51) Int. Cl. G11B 7/00; G11B 5/09

(52) U.S. Cl. 369/59.1; 369/47.5; 369/53.1; 369/124.01

(57) ABSTRACT

The program is capable of writing data in optical disks with absolutely optimum set values. In the program, a command sending function performs the steps of sending commands to make an optical disk apparatus read data from an optical disk; measuring pulse widths of high level sections and low level sections of a binarized RF signal of the data; collecting the pulse widths of the high level sections and number of each pulse width thereof and the pulse widths of the low level sections and number of each pulse width thereof as collected data; making the optical disk apparatus send the collected data to the host computer; and making the host computer analyze the collected data so as to perform an adjusting function, which automatically calculates optimum set values for writing data.

### BACKGROUND OF THE INVENTION

The present invention relates to an optical disk apparatus, which can be connected to a host computer and can write data in an optical disk, and a program for controlling the optical disk apparatus, which can be read by the host computer.

These days, writable optical disks, e.g., CD-R/RW, DVD+R/RW, have been widely provided. Many manufacturers manufacture optical disks around the world. Consumers can buy inexpensive optical disks. On the other hand, optical disk apparatuses are required to be capable of writing high quality data in different types of optical disks, which respectively have unique characteristics.

Conventionally, identification data, which identify types of optical disks, set values for writing data, etc. have been previously written in writable optical disks.

For example, in a CD-R, disk identification data, e.g., a name of manufacturer, writable velocities, used dyes, are written in a specific area, which is located on the inner side of a user data area. In a conventional optical disk apparatus (a CD-R player), set values for writing data, e.g., strategy, which respectively correspond to identification data of popular CD-Rs, are previously stored in memory means, e.g., ROM, of the optical disk apparatus. To write data in a CD-R with high quality, the set values read from the CD-R are suitably varied to define optimum set values.

In a DVD+R, an optimum strategy for writing data is written in an ADIP of the DVD+R. Thus, a conventional optical disk apparatus (a DVD+R player) writes data in the DVD+R with the optimum strategy read from the ADIP.

However, quality of optical disks vary even if they are same type disks. Even if a type of an optical disk is detected on the basis of an identification datum or data are written in the optical disk with the written strategy, set values or the strategy is not always optimum values or strategy for writing data in the optical disk.

To write data in an optical disk with optimum set values, e.g., write-power, an improved optical disk apparatus and an improved method of writing and reproducing data are disclosed in Japanese Patent Gazette No. 2002-123943.

In the Japanese gazette, an optimum write-power is determined by the steps of: test-writing a plurality of data in an OPC with different write-powers; measuring jitters of the written data; and selecting the optimum write-power of the optical disk.

By using the optical disk apparatus and the method, data can be written in the optical disk with the optimum write-power.

Some conventional optical disk apparatuses have memory means, e.g., ROM, for previously storing set values corresponding to identification data of optical disks. However, new types of optical disks are continuously released from manufacturers around the world, so manufacturers should measure optimum set values of the new disks and write them in the memory means. The works take thousands of man-hours.

Further, if a new optical disk is released after the optical disk apparatus is sold, the set values of the new optical disk should be written in the memory means of the optical disk apparatus. Conventionally, the set values are rewritten by rewriting the memory means, e.g., flash ROM, or updating a firmware. This work is very hard and troublesome for users and manufacturers. Further, a user cannot write data in the new optical disk with the optimum set values until installing the updated firmware in his optical disk apparatus. Manufacturers must continuously check information of new optical disks released from manufactures around the world.

In a case of writing data with a strategy written in an ADIP, etc. of an optical disk, the optical disk player can know optimum strategies of optical disks. However, optical disk apparatuses have different write-mechanisms, e.g., laser drivers. Even if an optimum strategy is set, actual laser powers of optical disk apparatuses are slightly different. Therefore, a strategy written in an optical disk is not always an optimum strategy for an optical disk apparatus.

In the method of determining an optimum write-power by measuring jitter values of test-written data in an OPC step, an optimum write-power of each optical disk can be determined. However, it is very troublesome for manufacturers to measure optimum set values of optical disks and to recreate firmwares of optical disk apparatuses. Therefore, only simplified algorithms, which can be executed by the firmwares, are employed, so it is difficult to set optimum set values.

When data are miss-written with an optimum write-power, which is determined by an optical disk apparatus, or a trouble of writing data occurs, a user or a manufacturer cannot know the actual write-power. Therefore, it is difficult to find the cause of miss-writing and to take countermeasures against the troubles.

When an algorithm for determining an optimum write-power is modified, memory means or a firmware stored in, for example, a flash ROM must be rewritten, so this work is troublesome for users and manufacturers.

These days, prices or optical disks have been reduced, so low-quality optical disks are increased. In the conventional disk apparatuses, rate of miss-writing in low-quality optical disks is high. For example, in the conventional optical disk apparatuses, data were miss-written in eight optical disks out of ten.

Note that, it is necessary to evaluate quality of data written in an optical disk so as to determine an optimum write-power of the optical disk. Conventionally, jitter values or an error rate is measured to evaluate quality of data.

Further, quality of written data can be evaluated by measuring pulse widths (time lengths) of high(H)-level sections and low(L)-level sections of a binarized RF signal (see FIG. 14).

The H-level sections and the L-level sections are alternately included in the binarized RF signal. The H-level sections indicate high light intensity of laser beams, which are reflected from lands formed in an recording surface of the optical disk and which are received by an optical pick-up; the L-level sections indicate low light intensity of laser beams, which are reflected from pits formed in the recording surface of the optical pick-up and which are received by the optical pick-up.

The pulse widths of the H-level sections and the L-level sections of the binarized RF signal depend on lengths of the lands and the pits formed in the recording surface of the optical disk (see FIG. 15).

In the optical disk, the lengths of the lands and pits are predetermined. The lands and pits are formed in a CD by irradiating EFM (Eight to Fourteen Modulation)-modulated laser beams from an optical pick-up or formed in a DVD by irradiating EFM⁺-modulated laser beams from the optical pick-up. By forming the lands and pits, data can be written or recorded in the optical disk.

By EFM-modulating or EFM⁺-modulating signals, the lengths of the lands and pits are determined on the basis of clock frequency.

In the following description, a standard length of the land and pit is defined as “T”. Actually, the lengths of the lands and pits formed in, for example, a DVD are 3T, 4T, . . . , 14T (except 12T and 13T). Namely, the length of the lands and pits are multiples of T.

Thus, quality of the recorded data can be evaluated by measuring pulse widths of the H-level sections and the L-level sections of the binarized RF signal and calculating deviations of the measured pulse widths from the predetermined lengths 3T, . . . , 14T.

Unlike the method of measuring jitter values or an error rate, the above described method is capable of precisely evaluating quality of written data.

### SUMMARY OF THE INVENTION

An object of the present invention is to provide a program for controlling an optical disk apparatus and an optical disk apparatus, which are capable of: writing data in optical disks with absolutely optimum set values; easily determining optimum set values for writing data in optical disks in stages of developing optical disk apparatuses; writing data in new optical disks with optimum set values without supports of manufacturers of optical disk apparatuses; informing types of new optical disks, which have been used by users, data of miss-writing, etc.; and easily changing processes, e.g., algorithm, of determining optimum set values.

To achieve the object, the present invention has following structures.

Namely, in the program for controlling an optical disk apparatus, which is read by a host computer connected to the optical disk apparatus so as to write data in an optical disk and which has a function of making the host computer send commands for controlling the optical disk apparatus to the optical disk apparatus,
the command sending function performs the steps of:
sending commands to make the optical disk apparatus read data from the optical disk;
measuring pulse widths of high level sections and low level sections in a plurality of parts of a binarized RF signal of the data;
collecting the pulse widths of the high level sections and number of each pulse width thereof and the pulse widths of the low level sections and number of each pulse width thereof as collected data; and
making the optical disk apparatus send the collected data to the host computer; and
making the host computer analyze the collected data so as to perform an adjusting function, which automatically calculates optimum set values, e.g., strategy, laser power, for writing data.

With this program, the host computer knows the collected data, which include the pulse widths of the binarized RF signal of the written data and the number of the pulses, and suitable set values for writing data in the optical disk can be stored, managed and used. When the program is used for developing an optical disk apparatus, quality of written data corresponding to each set value can be easily known, work loads of development engineers, who determine optimum set values for writing data, can be reduced. The pulse widths of the the binarized RF signal clan be used as quality indicators of written data. The program is capable of more precisely determining the set values than other methods using jitter values and error rates.

In the program, the adjusting function may perform the steps of:
sending commands to the optical disk apparatus so as to read desired set values for writing data, which have been previously written in the optical disk, or initial set values for writing data, which have been previously stored in the optical disk apparatus;
sending the desired set values or the initial set values to the host computer;
making the host computer, which has received the desired set values or the initial set values, send commands to the optical disk apparatus so as to write data in the optical disk a plurality of times with different set values, which are based on the desired set values or the initial set values;
sending commands to the optical disk apparatus so as to read a plurality of the written data from the optical disk;
measuring pulse widths of high level sections and low level sections in a plurality of parts of a binarized RF signal of the data;
collecting the pulse widths of the high level sections and number of each pulse width thereof and the pulse widths of the low level sections and number of each pulse width thereof for each setting value as collected data;
making the optical disk apparatus send the collected data to the host computer; and
making the host computer select the best quality data from the collected data and determining the set values of the best quality data as optimum set values for writing data.

With this program, the host computer can know variations of lengths of lands and pits formed on a recording surface of the optical disk, etc. by measuring the pulse widths of the binarized RF signal, so that optimum set values can be determined on the basis of the measured results. Therefore, the set values, e.g., strategy, can be precisely determined, and quality of written data can be improved.

The program may make the host computer create a log file including: identification data written in optical disks for identifying types of optical disks; the set values for writing data; and the collected data.

With this program, the log file, which includes the identification data of types of optical disks, the adjusted set values for writing data in the optical disk, and the collected data, can be gained, so that each data of each type of optical disks can be efficiently known so as to adjust the set values. Therefore, causes of miss-writing data, quality of written data, etc. can be efficiently analyzed.

The program may make the host computer send the log file to another computer via a communication line.

With this program, the log fine can be easily used by another computer. For example, a development engineer can share the log file with another engineer by sending the log file.

The program may make the host computer send the log file to a computer of a manufacturer of the optical disk;
the host computer receives the set values for writing data from the computer of the manufacturer, and
the set values sent from the computer of the manufacturer may be used as the set values of the optical disk apparatus for writing data in the optical disk.

With this program, the log file, which is used by an ordinary user, can be sent to the manufacturer, so that characteristics of the optical disk, causes of miss-writing data, etc. can be rapidly and precisely sent to the manufacturer. Therefore, the manufacturer can rapidly support the user. And the manufacturer can analyze the sent log file to determine optimum set values, the optimum set values can be sent from the manufacturer, so that the user can write data with the optimum set values.

The program may make the host computer send the log file to another computer, which has an electronic bulletin board downloadable via a communication line;
wherein said program is capable of downloading the log file placed on the electronic bulletin board, and
the set values included in the downloaded log file may be used as the set values of the optical disk apparatus for writing data in the optical disk.

With this program, the log file can be publicly disclosed on the electronic bulletin board. Therefore, users and the manufacturer can share information including write-characteristics of optical disks, etc. And with this program, a user is capable of writing data in the optical disk with set values placed by other users, which have been determined on the basis of quality tests.

Further, in the optical disk apparatus, which is capable of writing data in an optical disk and which can be connected to a host computer, comprising means for analyzing and executing commands sent from the host computer, the analyzing-and-executing means is capable of analyzing and executing:
a command for setting set values for writing data;
a command for writing data in the optical disk with the set values;
a command for measuring pulse widths of high level sections and low level sections in a plurality of parts of a binarized RF signal of the data;
a command for collecting the pulse widths of the high level sections and number of each pulse width thereof and the pulse widths of the low level sections and number of each pulse width thereof as collected data; and
a command for sending the collected data to the host computer;
a command for receiving optimum set values of optical disks from the host computer and storing the optimum set values, which respectively correspond to identification data written in optical disks for identifying types of optical disks, in memory means, and
the writing command may read the optimum set values corresponding to the identification datum of the optical disk from the memory means and writes data in the optical disk with the read optimum set value.

With this optical disk apparatus, the host computer writes data with various set values and gains the collected data, which include the pulse widths of the binarized RF signal of the written data and the number of the pulses so as to evaluate variations of lengths of lands and pits. When the program is used for developing an optical disk apparatus, the collected data, which are the pulse widths of the binarized RF signal, can be efficiently known. If the user sends the collected data to a manufacturer, the manufacturer can know write-characteristics of the optical disk, causes of miss-writing data, etc. Therefore, the manufacturer can rapidly support the user. The pulse widths of the the binarized RF signal can be used as quality indicators of written data. The program is capable of more precisely determining the set values than other methods using jitter values and error rates. And with this apparatus, the optimum set values, which have been once determined and which correspond to each type of optical disks, are stored, so the stored optimum set values can be applied to the same types. Therefore, the process of determining the optimum set values need not be executed for each optical disk, and data-writing can be rapidly performed.

### BRIEF DESCRIPTION OF THE DRAWINGS

Embodiments of the present invention will now be described by way of examples and with reference to the accompanying drawings, in which:

FIG. 1 is a block diagram of a host computer of an embodiment of the present invention, which includes a program for controlling an optical disk apparatus;

FIG. 2 is a block diagram of the optical disk apparatus;

FIG. 3 is an explanation view of collecting pulse widths;

FIG. 4 is a block diagram of a control section of the optical disk apparatus;

FIG. 5 is a flow chart of a macro program;

FIG. 6 is a flow chart of a routine work of the macro program, which reads set values written in an optical disk;

FIG. 7 is a flow chart of a routine work of the macro program, which adjusts set values;

FIG. 8 is a flow chart of a routine work of the macro program, which determines an optimum laser power;

FIG. 9 is a flow chart of a routine work of the macro program, which determines a first parameter of an optimum strategy;

FIG. 10 is a graph showing distribution of high level sections and low level sections based on collected data;

FIG. 11 is an explanation view explaining evaluation of data quality based on deviation of peaks of mountain-shaped waves;

FIG. 12 is an explanation view explaining evaluation of data quality based on widths of the mountain-shaped waves;

FIG. 13 is a block diagram of a system for controlling the optical disk apparatus;

FIG. 14 is an explanation view of a binarized RF signal; and

FIG. 15 is an explanation view showing lands and pits formed on a recording surface of the optical disk.

### DESCRIPTION OF THE PREFERRED EMBODIMENTS

Preferred embodiments of the present invention will now be described in detail with reference to the accompanying drawings.

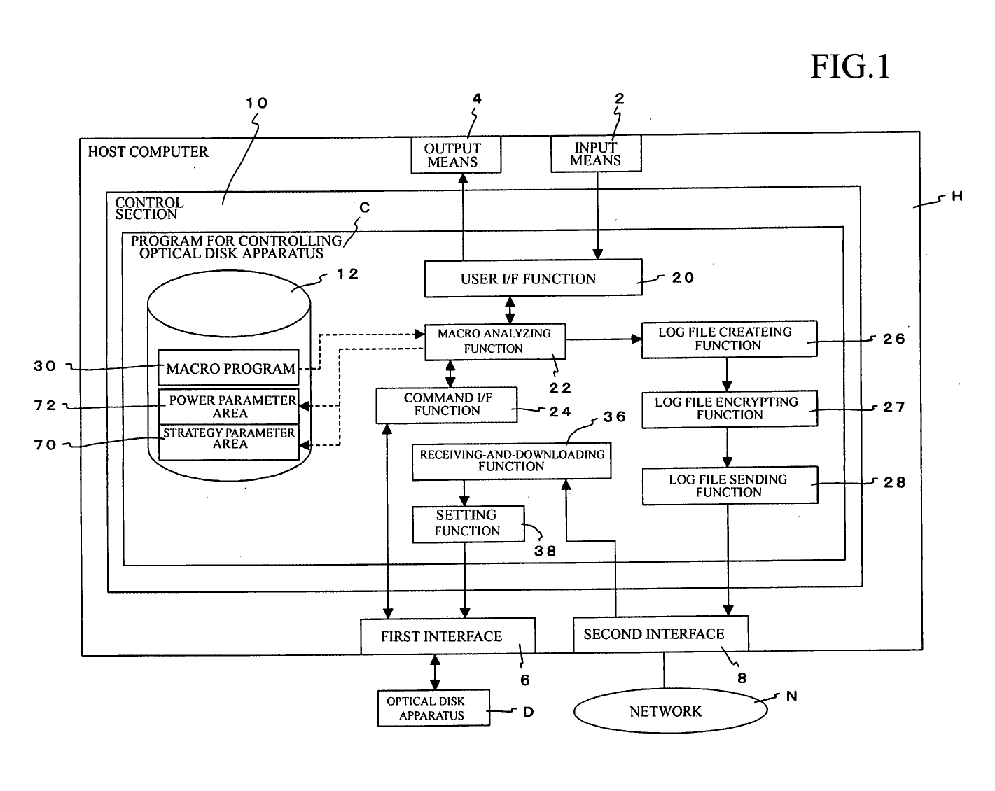

FIG. 1 is a block diagram of a host computer H, in which a program of the present embodiment, which controls an optical disk apparatus D, is installed. The host computer H is connected to the optical disk apparatus D so as to send and receive data.

The host computer H has: input means 2, e.g., keyboard, mouse, by which a user inputs data, etc.; display means 4, e.g., display unit; a first interface 6, e.g., ATAPI, USB, for communicating with the optical disk apparatus D; a second interface 8 for communicating with other computers via a network N, e.g., LAN, internet; and a control section 10, which includes a CPU, memories, hard disk, etc. so as to execute programs.

A program C for controlling the optical disk apparatus D is installed in the control section 10 of the host computer H. Namely, the host computer H can read the program C.

The program C makes the host computer H perform a user interface (I/F) function 20, which receives data inputted by the input means 2 and shows processed information in the display means 4, and a macro analyzing-and-executing function 22, which analyzes and executes a macro program 30.

The program C is executed by the control section 10, and the program C makes the host computer H perform a command interface (I/F) function 24, which sends various commands, which are included in the macro program 30 analyzed by the macro analyzing-and-executing function 22, to the optical disk apparatus D via the first interface 6.

Further, the program C is executed by the control section 10, and the program C makes the host computer H perform a log file creating function 26, which creates a log file in which results of the macro program 30 executed by the macro analyzing-and-executing function 22, a log file encrypting function 27, which encrypts the log file, and a log file sending function 28, which sends the encrypted log file to other computers via the second interface 8 and the network N.

The program C is executed by the control section 10, and the program C makes the host computer H perform a receiving-and-downloading function 36, which receives or downloads written set values for writing data, the log file, etc. from other computers via the second interface 8 and the network N, and a setting function 38, which sets the written set values or set values recorded in the log file, which are received or downloaded by the receiving-and-downloading function 36, in the optical disk apparatus D so as to write data in an optical disk with the received or downloaded set values.

The macro program 30 includes commands to be sent to the optical disk apparatus D, various process, etc. The macro program 30 includes a set value adjusting function, which analyzes collected data gained by the command interface (I/F) function 24 and automatically calculates optimum set values for writing data, e.g., strategy, laser power.

The macro program 30 can be rewritten by a user and replaced with other macro program files. Further, if a plurality of macro programs 30 are installed, the user may select the macro program 30 to be executed by the macro analyzing-and-executing function 22 from them.

The host computer H is connected to other computers (not shown) via the network N, e.g., LAN, internet, dedicated line.

For example, if the host computer H and the optical disk apparatus D are used by a development engineer of a manufacturer of the optical disk apparatus, the host computer H may be connected to an in-house LAN so as to communicate with other in-house computers. On the other hand, if the host computer H and the optical disk apparatus D are used by an ordinary user, the host computer H may be connected to a computer of the manufacturer of the optical disk apparatus via the internet, etc.

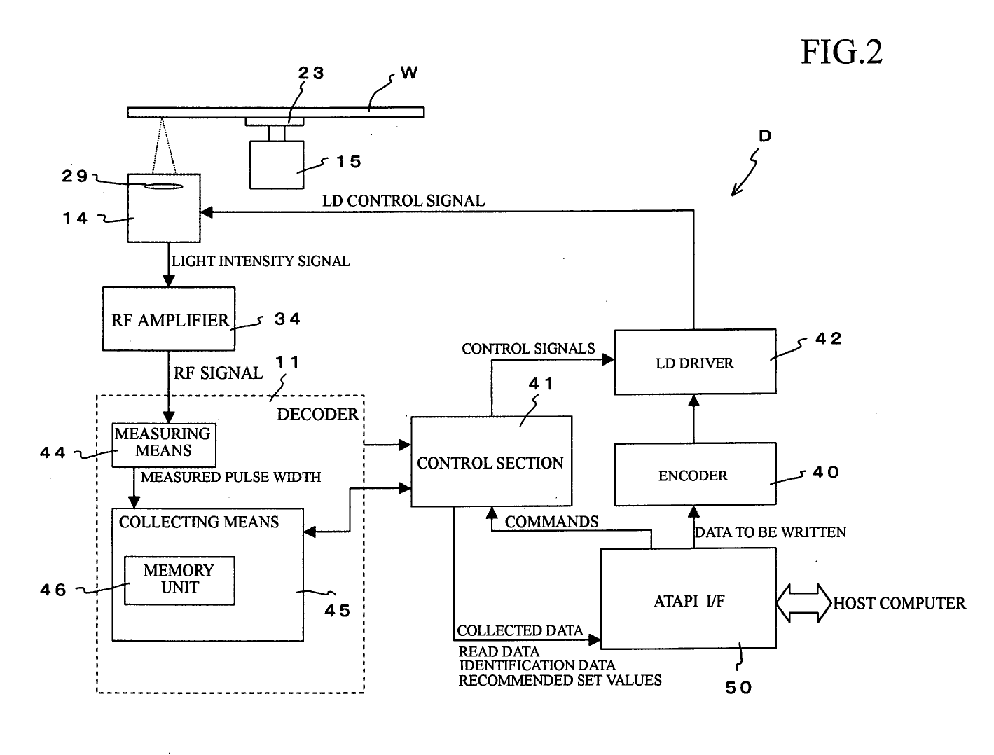

Next, the optical disk apparatus D will be explained with reference to FIGS. 2-4.

The optical disk apparatus D comprises: a turn table 23, on which an optical disk W is set; a spindle motor 15 for rotating the turn table 23; and an optical pick-up 14 for irradiating a laser beam toward the optical disk W and receiving the laser beam reflected from the optical disk W.

The optical pick-up 14 includes a laser diode (not shown) for irradiating the laser beam and a photo diode (not shown), which acts as a light receiving element. Further, an object lens 29, which focuses the laser beam to a recording layer of the optical disk W, is provided in the optical pick-up 14.

The photo diode converts intensity of the received reflected laser beam into voltage and sends a voltage signal. The voltage signal outputted from the optical pick-up 14 is sent to an RF amplifier 34.

The RF amplifier 34 shapes waveforms of the voltage signal from the optical pick-up 14 and binarizes the voltage signal so as to generate a binarized RF signal.

As shown in FIG. 14, high (H) level sections and low (L) level sections are alternately appear in the binarized RF signal. The intensity of the reflected laser beam corresponding to the H-level sections are high, namely the H-level sections correspond to lands in the recording face of the optical disk W. On the other hand, the intensity of the reflected laser beam corresponding to the L-level sections are low, namely the L-level sections correspond to pits in the recording face of the optical disk W.

The binarized RF signal is sent to a decoder 11. The decoder 11 performs a decoding process, e.g., EFM-demodulating the binarized RF signal, and sends decoded data (read data in FIG. 2) outside via an interface 50.

The optical disk apparatus D has the interface 50 for connecting to external equipments. Several types of the interface 50, e.g., ATAPI (AT Attachment Packet Interface), USB (Universal Serial Bus), IEEE1394, can be employed.

In the present embodiment, the optical disk apparatus employs the ATAPI type interface 50 so as to connect to the host computer H.

When the interface 50 receives various data for writing and various commands from an external equipment, e.g., the host computer H, the interface 50 sends the data for writing to an encoder 40 and sends the commands to a control section 41.

The data for writing are, for example, EFM-modulated in the encoder 40, and the encoded data are sent to a laser diode (LD) driver 42.

The LD driver 42 sends a LD control signal to the optical pick-up 14 on the basis of the encoded data so as to control driving voltage applied to the laser diode of the optical pick-up 14. The LD driver 42 is controlled on the basis of various control signals sent from the control section 41.

Pulse widths of the binarized RF signal are measured by measuring means 44. In the present embodiment, the measuring means 44 is one of functions of an IC, which acts as the decoder 11 for decoding the binarized RF signal.

However, the measuring means 44 is not limited to the present embodiment. For example, a circuit for or a software capable of measuring pulse widths may be employed as the measuring means.

Pulse widths of the H-level sections and the L-level sections of the binarized RF signal, which have been measured by the measuring means 44, are sent to the collecting means 45.

The collecting means 45 includes: a memory unit 46 for collecting the pulse widths and number of pulses for each pulse width e; and the control unit 41 for controlling the memory unit 46.

In the present embodiment, the collecting means 45 is one of functions of the IC, which acts as the decoder 11 for decoding the binarized RF signal, as well as the measuring means 44. However, the collecting means 45 is not limited to the present embodiment. For example, a circuit separated from the IC may be employed as the collecting means.

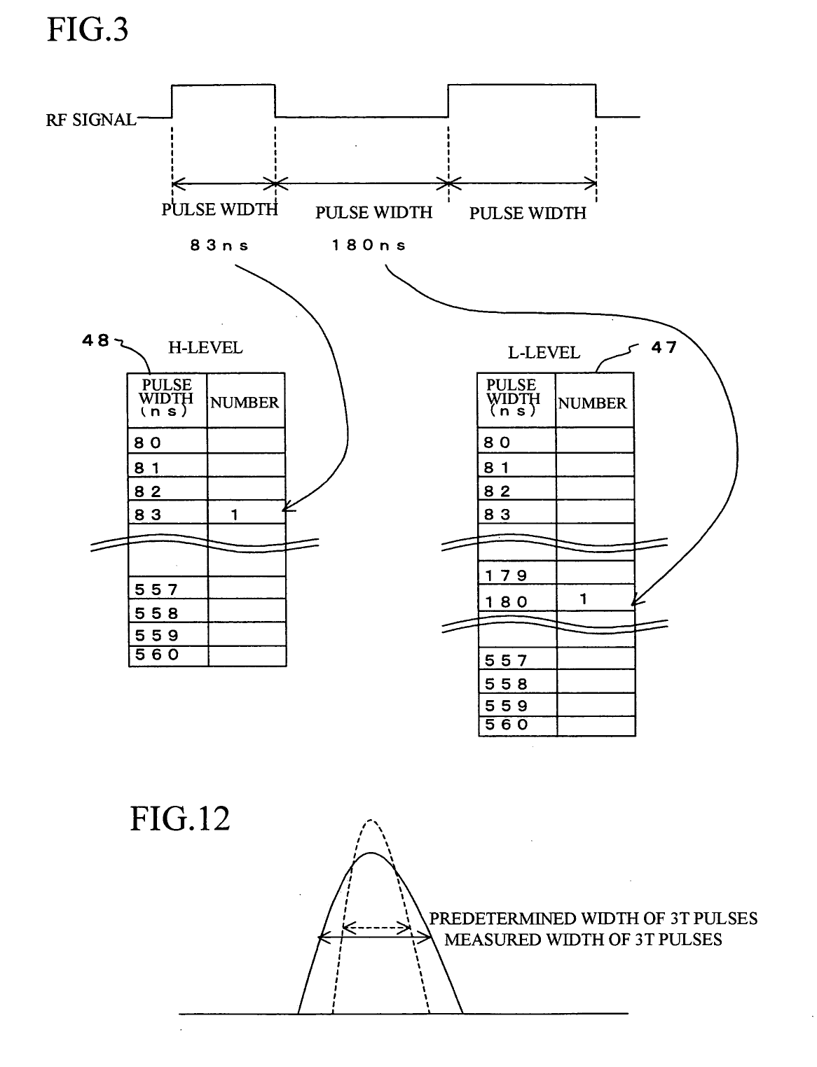

A data collecting method performed by the collecting means 45 will be explained with reference to FIG. 3.

The memory unit 46 of the collecting means 45 includes: a table 48 for storing pulse widths of the H-level sections and number of pulses for each pulse width thereof; and a table 47 for storing pulse widths of the L-level sections and number of pulses for each pulse width thereof. Namely, in the optical disk apparatus D of the present embodiment, the pulse widths of the H-level sections and the L-level sections, which are between a minimum value 3T, e.g., 80 ns, and a maximum value 14T, e.g., 560 ns, and number of pulses for each pulse width are respectively stored in the tables 48 and 47.

For example, when the measuring means 44 measures the H-level section of the binarized RF signal having pulse width of 83 ns and the L-level section having pulse width of 180 ns, the control unit controls the memory unit 46 to store number one for the pulse width 83 ns of the H-level pulse and number one for the pulse width 180 ns of the L-level pulse.

Then, the measuring means 44 continuously measures pulse widths of the H- and L-level sections of the binarized RF signal, and the control unit adds one to the number for each measured pulse width stored in the memory unit 46.

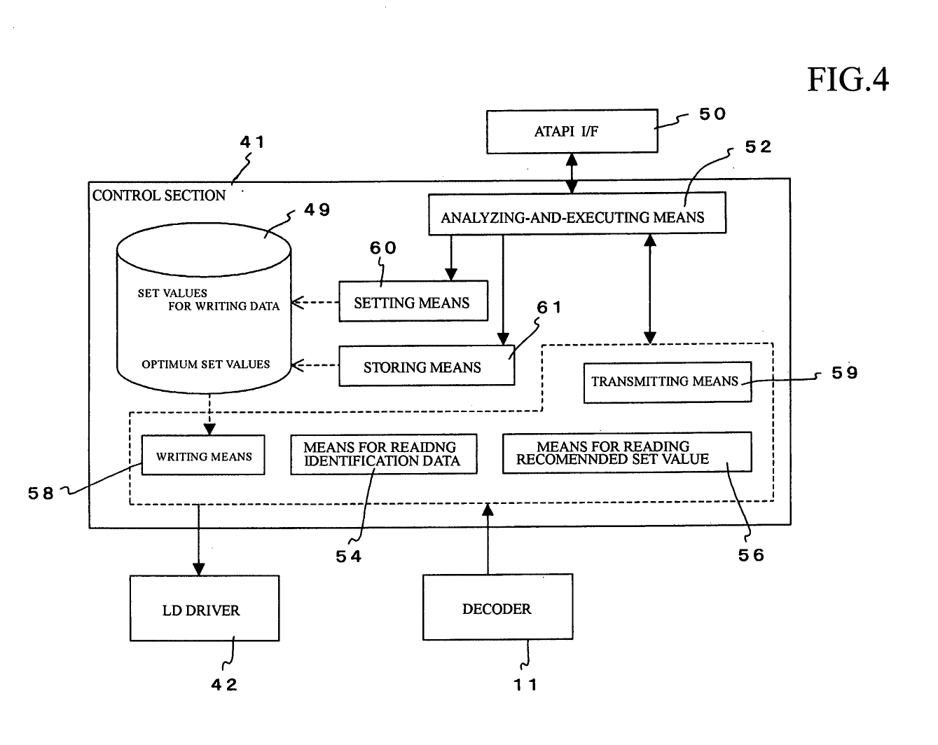

Next, the action of the control section 41 will be explained with reference to FIG. 4.

The control section 41 includes a CPU, memories, etc. and executes firmwares, which are stored in, for example, a flash ROM as programs.

The optical disk apparatus D comprises: means 52 for analyzing and executing commands sent from the host computer H; means 54 for reading identification data, which called and executed by the analyzing-and-executing means 52 when the analyzing-and-executing means 52 analyzes a command for reading identification data; means 56 for reading recommended set values for writing data, which is executed when the analyzing-and-executing means 52 analyzes the command for reading identification data; writing means 58, which is executed when a write-command is analyzed; means 59 for transmitting collected data, which is executed when a command for measuring data is analyzed; means 60 for setting set values for writing data, which is executed when a command for setting set values is analyzed; means 61 for storing optimum set values, which is executed when a command for storing optimum set values is analyzed; and firmwares executed by the control section 41.

Note that, in the present embodiment, the command for reading identification data, the command for reading recommended set values, the write-command, the command for setting set values, the command for measuring data and the command for storing optimum set values are independent commands, but a function of each command may be performed by combining a plurality of commands. Further, functions of a plurality of the commands may be performed by one command.

The reading means 54 is constituted by a firmware capable of: reading the recorded disk identification data from the optical disk W, e.g., CD-R, DVD+R, which is set in the optical disk apparatus D by the optical pick-up 14, the RF amplifier 34 and the decoder 11; and sending the disk identification data to the host computer H by the analyzing-and-executing means 52 and the interface 50.

The reading means 56 is constituted by a firmware capable of: reading the recommended set values, which have been recorded, from the optical disk W, e.g., CD-R, DVD+R, which is set in the optical disk apparatus D by the optical pick-up 14, the RF amplifier 34 and the decoder 11; and sending the recommended set values to the host computer H by the analyzing-and-executing means 52 and the interface 50.

For example, the set values previously recorded in the optical disk W are strategy data recorded in an ADIP of a DVD+R, a laser power, etc.

The setting means 60 is constituted by a firmware capable of setting values, e.g., laser power, strategy, which have been assigned by the setting command, as the set values for writing data.

The set values for writing data are stored in the memory unit 49 of the optical disk apparatus D, and they are used when the writing means 58 control the LD driver 42 so as to write data in the optical disk W.

The storing means 61 is constituted by a firmware capable of: receiving optimum set values of optical disks from the host computer H; and storing the optimum set values corresponding to each identification data of optical disks in the memory unit 49 of the optical disk apparatus D. The optimum set values are used when the writing means 58 control the LD driver 42 so as to write data in the optical disk W.

The writing means 58 is constituted by a firmware capable of writing data, which have been assigned by the write-command, in an assigned address of the optical disk W, which have been assigned by the write-command, by the LD driver 42 and the optical pick-up 14. While writing data, the writing means 58 retrieves the set values or the optimum set values from the memory unit 49 and writes data with the retrieved set values.

To write dada in the optical disk, the user can select the set values or the optimum set values. The set values or the optimum set values are selected by selecting parameters of the write-command or by selecting the write-command corresponding to the set values or the optimum set values.

The transmitting means 59 is constituted by a firmware capable of: reading written data, which are written at an address in the optical disk W assigned by the measuring command; measuring the pulse widths of H-level sections and L-level sections of a binarized RF signal of the data; and collecting the pulse widths of the high level sections and number of each pulse width thereof and the pulse widths of the low level sections and number of each pulse width thereof by controlling the optical pick-up 14, the RF amplifier 34, the measuring means 44 and the collecting means 45. Further, the transmitting means 59 transmits the collected data, which have been collected by the collecting means 45, to the host computer H.

Next, the macro program 30 stored in the host computer H will be explained.

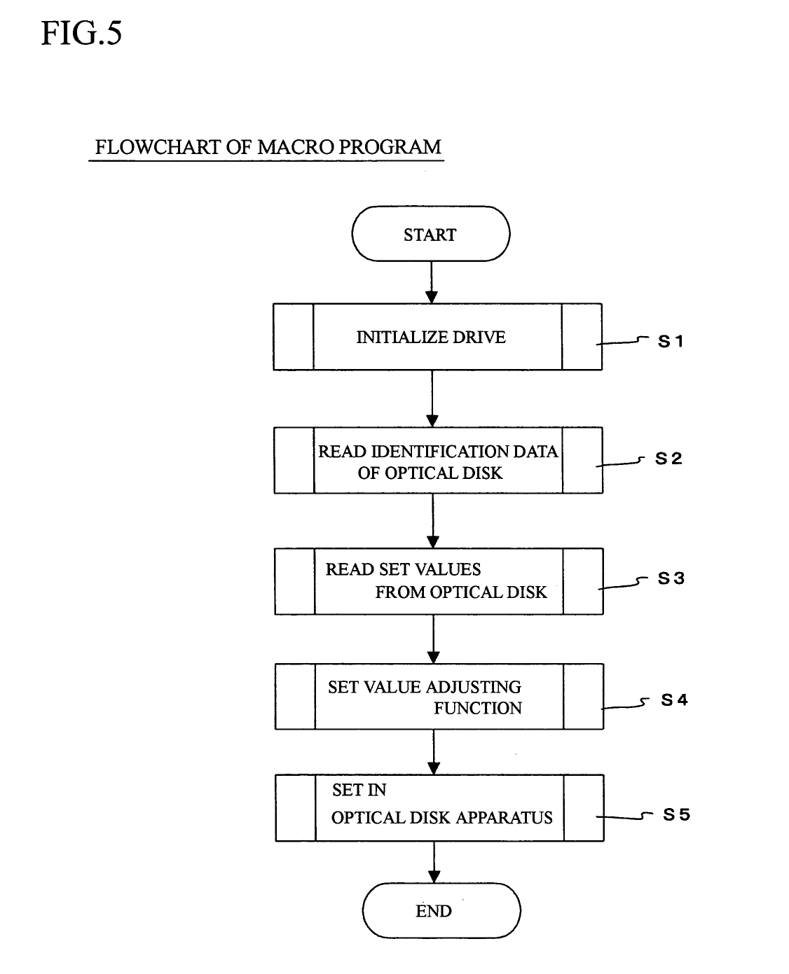

FIG. 5 is a flowchart of the macro program 30.

The macro program 30 is constituted by: a routine work S1 for initializing a drive, which includes commands for initializing the drive of the optical disk apparatus D when the optical disk W is set in the optical disk apparatus D; a routine work S2 for reading disk identification data, which includes the command for reading the disk identification data written in the optical disk W; a routine work S3 for reading set values, e.g., strategy and laser power previously written in an ADIP of a DVD+R, which includes the command for reading the recommended set values, which have been previously written in the optical disk W; a routine work S4 for executing the set value adjusting function; and a routine work S5 for setting optimum set values, which includes the setting command for setting the optimum set values, which have been determined by the routine work S4, in the optical disk apparatus D so as to write data in the optical disk W with the optimum set values.

The routine work S2 of the macro program 30 includes: the commands for reading the identification data; a command for storing the identification data sent from the optical disk apparatus D in the memory means of the host computer H; and a command for writing the identification data in a log file with the log file creating function 26.

The disk identification data written in the optical disk W are, for example, a name of a disk manufacturer, writing velocities, used dyes, etc. written in the ADIP of the DVD+R medium.

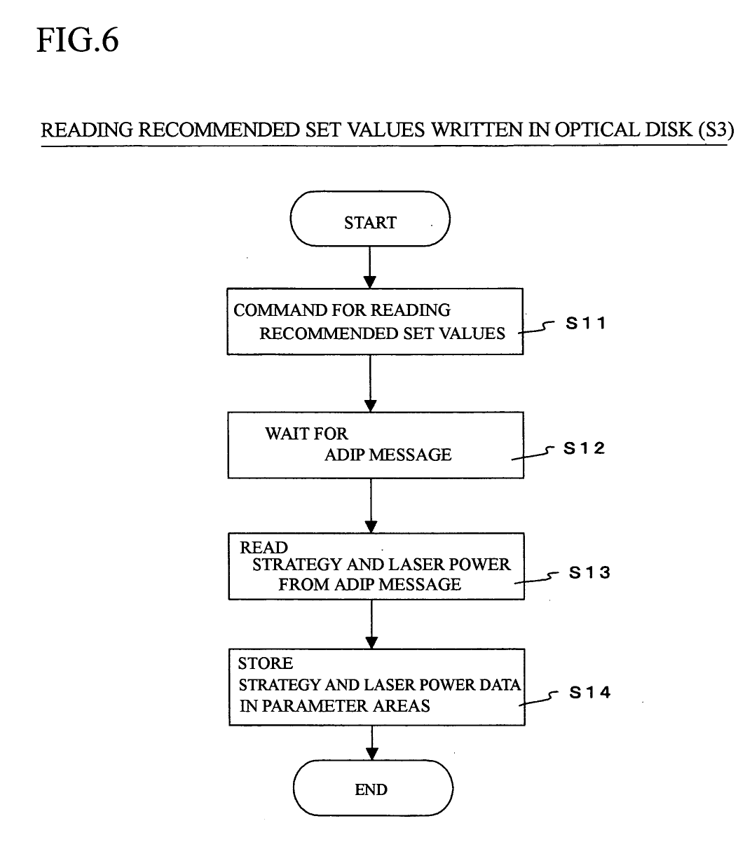

A flowchart of the routine work S3 is shown in FIG. 6. The flowchart shows a process of reading the strategy data and the laser power data from the ADIP of the DVD+R.

The routine work S3 includes: a routine work S11 including a command for reading the recommended set values; a step S12 of waiting for an ADIP message from the optical disk apparatus D, which is a response message to the reading command of the routine work S11; a step S13 of reading the strategy and the laser power included in the ADIP message; and a step S14 of storing first to seventh parameters of the read strategy data in a strategy parameter area 70 of the memory means 12 of the host computer H and storing the laser power data in a power parameter area 72 thereof.

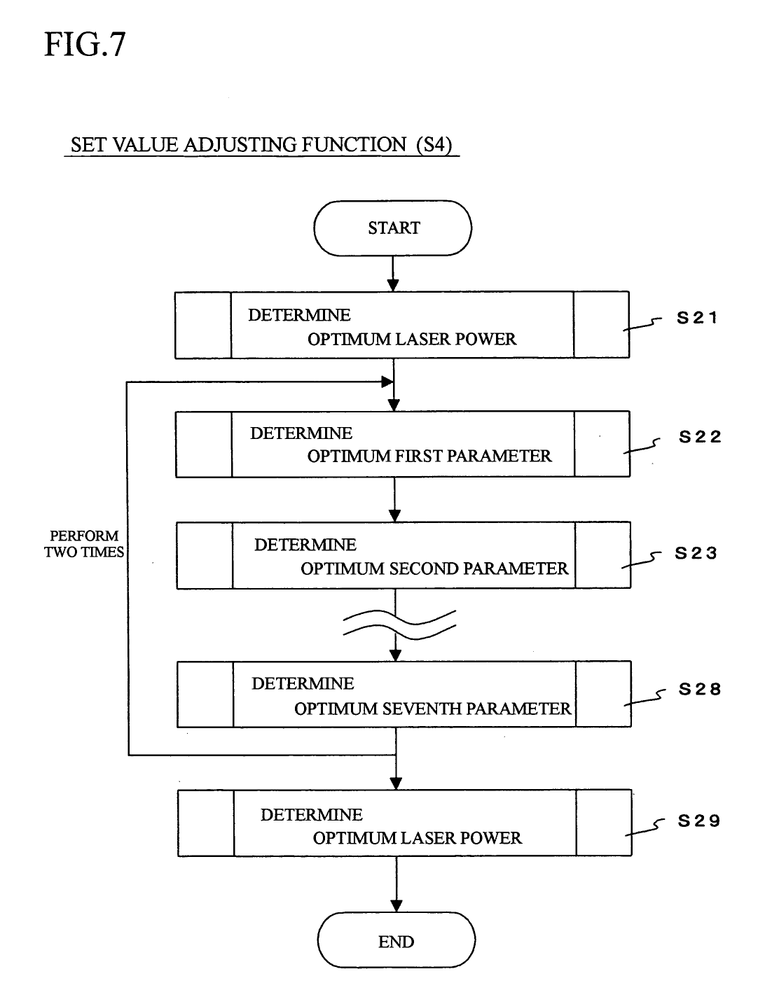

A flowchart of the routine work S4 for executing the set value adjusting function is shown in FIG. 7.

The routine work S4 includes: a routine work S21 for writing data with five different laser powers, which are determined on the basis of the strategies defined by the first to seventh parameters stored in the parameter area 70, and determining the optimum laser power oh the basis of the collected data of the binarized RF signals of the five written data; routine works S22-28, in each of which five data are written with the laser power determined by the routine work S21 and different strategy parameters X (X=1-7, which respectively correspond to the routine works S22-28), optimum parameters X are determined on the basis of the collected data of the binarized RF signals of the five written data, and the optimum parameters X are stored in the in the parameter area 70; and a routine work S29 for executing the process similar to the routine work S21. Note that, the routine works S24-27, in which the optimum third to sixth parameters are determined, are omitted in FIG. 7.

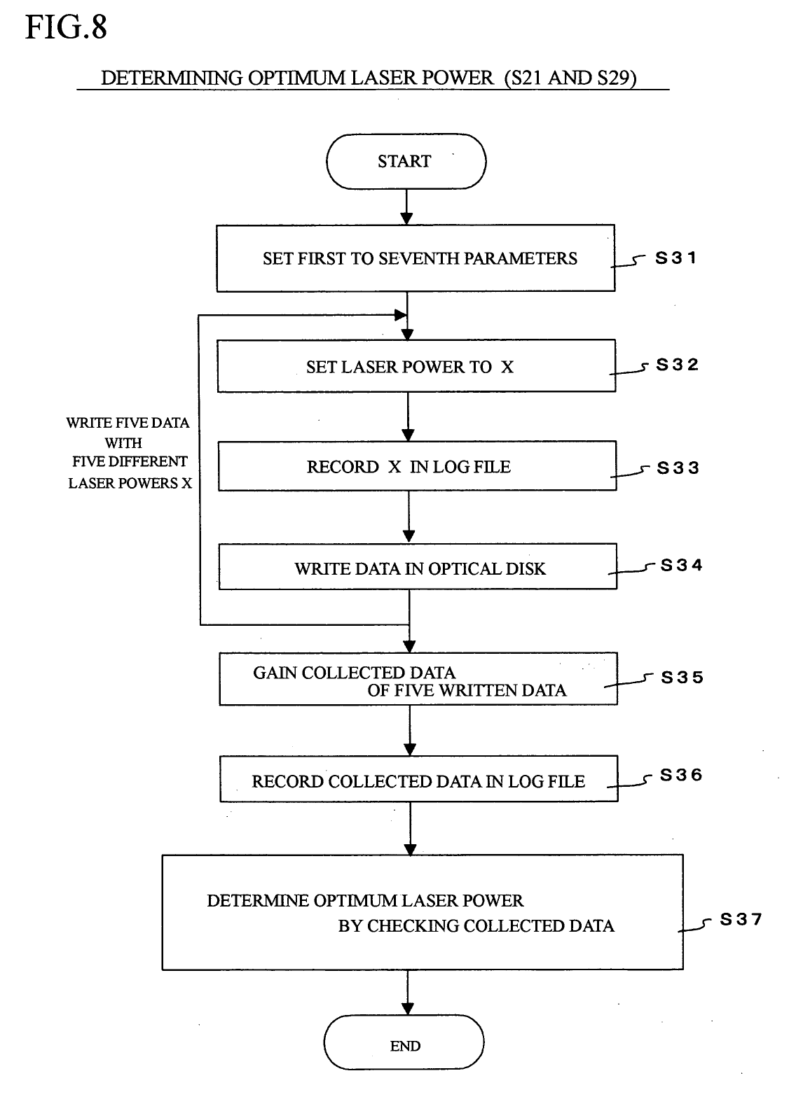

The routine works S21 and S29, in which the optimum laser power is determined, will be explained with reference to FIG. 8.

Each of the routine works S21 and S29 includes: a step S31 of reading the first to seventh parameters stored in the parameter area 70 and setting the first to seventh parameters in the optical disk apparatus D, with the setting command, as the set values for writing data; a step S32 of setting the values X in the optical disk apparatus D, as the laser power set values, with the setting command; a step S33 of writing the values X in a log file by the log file creating function 26; a step S34 of writing prescribed data at a prescribed address in a user data area of the optical disk W by the optical disk apparatus D with the write-command; a step S35 of obtaining the collected data of the binarized RF signals of the written data by the optical disk apparatus D with the measuring command; and a step S36 of writing the collected data obtained by the step S35 in the log file by the log file creating function 26.

In a step S37 following the step S36, an optimum laser power is determined by checking the collected data. Namely, a preferred collected data, in which a pulse width of pulses of a peak pulse number is equal to or very close to a predetermined value and a width of a distribution curve corresponding to the peak pulse number is equal to or very close to a predetermined value, are selected. The laser power of the preferred collected data is determined as the optimum laser power. The optimum laser power is stored in the parameter area 72 of the memory means 12.

The step S32 for setting the laser power and the step S33 for writing data are performed a plurality of times, e.g., five times, with different laser powers. The laser power values X are set on the basis of the recommended laser power read from the optical disk W. The steps are performed with a laser power two levels lower than a standard laser power, a laser power one level lower than the standard laser power, the standard laser power, a laser power one level higher than the standard laser power and a laser power two levels higher than the standard laser power.

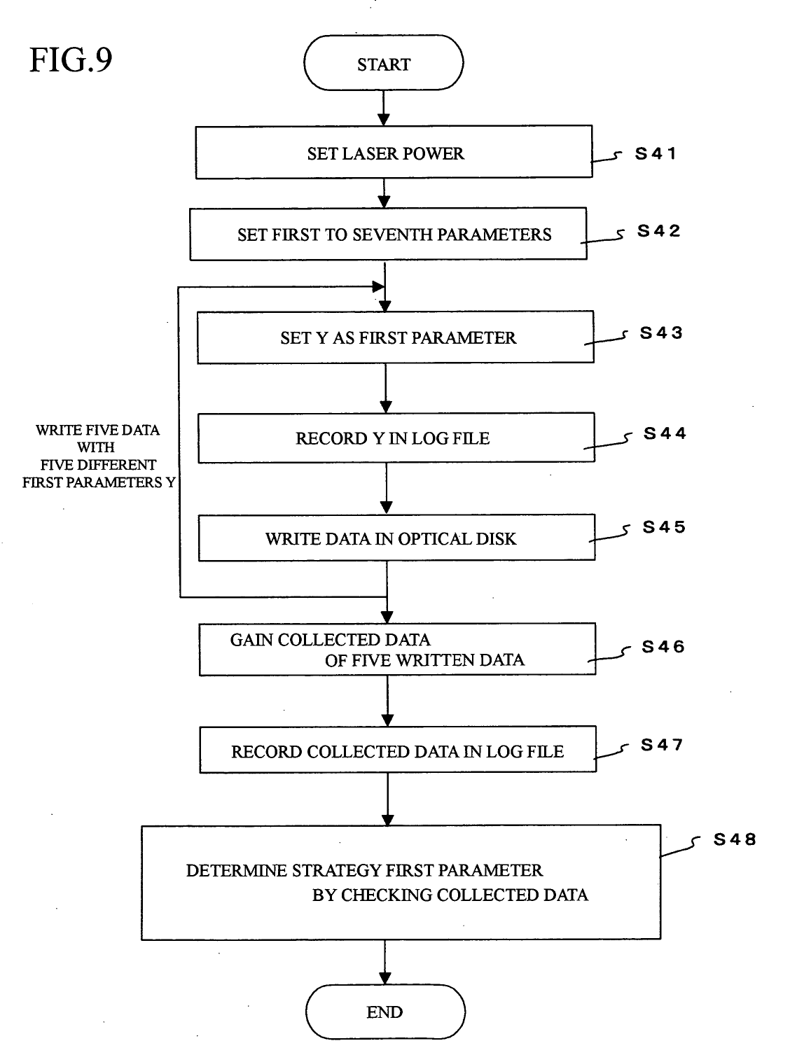

A flowchart of the routine work S22 (see FIG. 7) for determining the first parameter of the optimum strategy is shown in FIG. 9. The routine work S22 includes: a step S41 of reading the laser power value from the parameter area 72 and setting the laser power value in the optical disk apparatus D, as the set value for writing data, with the setting command; a step S42 of reading the first to seventh parameters from the parameter area 70 and setting the first to seventh parameters in the optical disk apparatus D, as the set values for writing data, with the setting command; a step S43 of setting the first parameter of the strategy in the optical disk apparatus D, as a predetermined value Y, with the setting command; a step S44 of writing the value Y in the log file by the log file creating function 26; a step S45 of writing prescribed data at prescribed address in the user data area of the optical disk W by the optical disk apparatus D with the write-command; a step S46 of obtaining the collected data of the binarized RF signals of the written data by the optical disk apparatus D; and a step S47 of writing the collected data obtained by the step S46 in the log file by the log file creating function 26.

In a step S48 following the step S47, an optimum first parameter of the strategy is determined by checking the collected data. Namely, a preferred collected data, in which a pulse width of pulses of a peak pulse number is equal to or very close to a predetermined value and a width of a distribution curve corresponding to the peak pulse number is equal to or very close to a predetermined value, are selected. The first parameter of the strategy of the preferred collected data is determined as the optimum first parameter of the strategy. The optimum first parameter of the strategy is stored in the parameter area 70 of the memory means 12.

The step S43 for setting the first parameter of the strategy and the step S44 for writing data are performed a plurality of times, e.g., five times, with different first parameter Y of the strategy. The first parameters Y of the strategy are set on the basis of the first parameter of the strategy read from the optical disk W. The steps are performed with a first parameter two levels lower than the stored first parameter, a first parameter one level lower than the stored first parameter, the stored first parameter, a first parameter one level higher than the stored first parameter and a first parameter two levels higher than the stored first parameter.

Note that, processes of the routine works S23-28, which determine the second to seventh parameters of the strategy, are equal to that of the routine works S22. Note that, the first parameter should be read as the second to seventh parameters in the routine works S23-28.

By executing the macro program 30 by the macro analyzing-and-executing function 22, the set value adjusting function is performed, so that the determined optimum set values for writing data can be stored in the parameter areas 70 and 72 (the routine work S4).

The optimum set values determined by the setting function (the routine work S5) are set in the optical disk apparatus D. The setting is performed by sending the optimum set values to the optical disk apparatus D and updating the set values or the optimum set values stored in the memory unit 49 of the optical disk apparatus D with the setting command or the storing command.

Further, the identification data of the optical disk W (the routine work S2), the set values for writing data (the steps S33 and S43) and the collected data (the steps S36 and S47) are written in the log file.

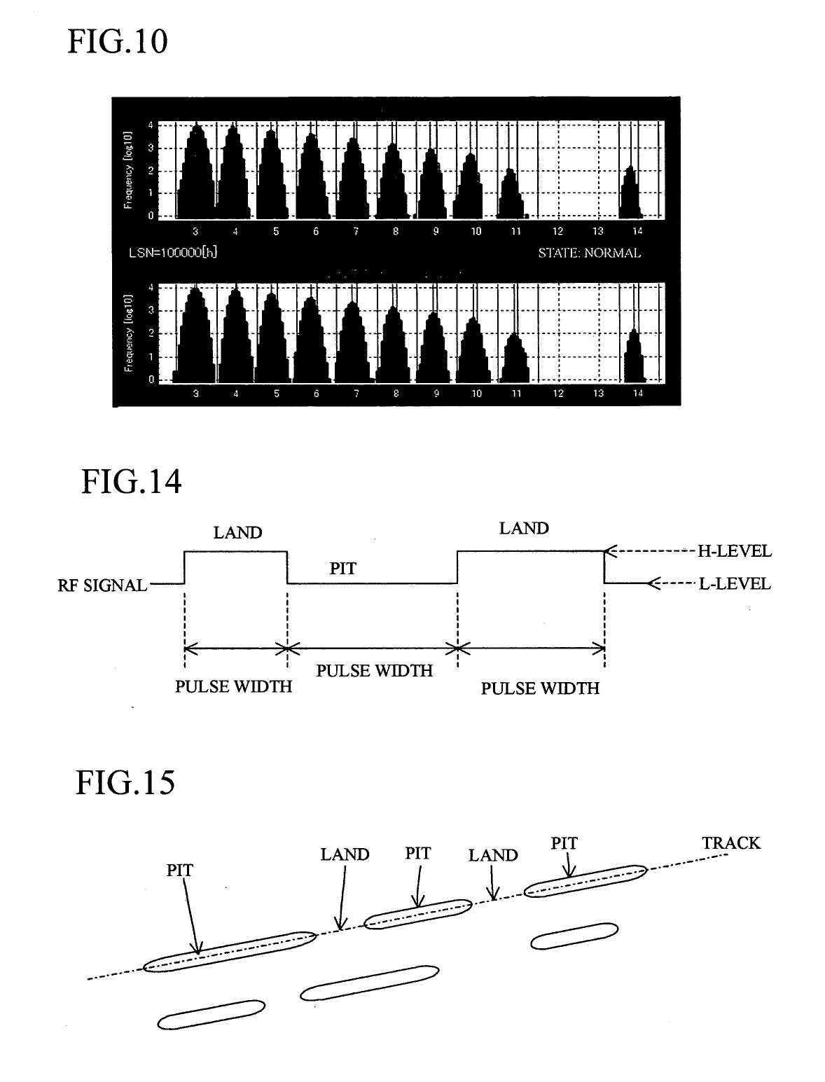

A concrete example of the set value adjusting function (the steps S37 and S48) will be explained with reference to FIGS. 10-12.

The host computer H creates frequency distribution graphs of the pulse widths of H-level sections and L-level sections and numbers thereof and adjusts the set values on the basis of the frequency distribution.

An example of the distribution graphs are shown in FIG. 10. In FIG. 10, an upper graph indicates the L-level sections of the binarized RF signal, which correspond to pits; a lower graph indicates the H-level sections of the binarized RF signal, which correspond to lands.

In the graphs, the horizontal axes indicate pulse width (unit: T), and the vertical axes indicate number of measured pulse widths or frequency thereof, which. Note that, the vertical axes are log-compressed.

In each graph, 10 mountain-shaped waves are observed, and their peaks respectively correspond to pulse widths of 3T, 4T, 5T, 6T, 7T, 8T, 9T, 10T, 11T and 14T.

There are several methods of evaluating quality of written data on the basis of the collected data, which are the pulse width data of the binarized RF signal. In the present embodiment, the quality of written data is evaluated by deviations of the peaks of the mountain-shaped waves and expansion of the mountain-shaped waves.

Namely, the pulse widths 3T, 4T, . . . are previously defined. The pulse width T is 38.2263 ns, so 3T is about 114 ns, 4T is about 153 ns, and 14T is about 535 ns. If the peak values of the mountain-shaped waves are deviated, the quality of the written data is low.

Further, if the mountain-shaped waves are expanded and the adjacent waves are overlapped, variation of the pulse widths with respect to the predetermined values is great; quality of the written data is low. On the other hand, if the mountain-shaped waves are thin and the adjacent waves are separated, almost the pulse widths are near the predetermined values; quality of the written data is high.

The above described method of evaluating quality of written data will be explained.

Firstly, detecting deviations of peaks of the distribution of the H-level sections and the L-level sections from predetermined peaks will be explained.

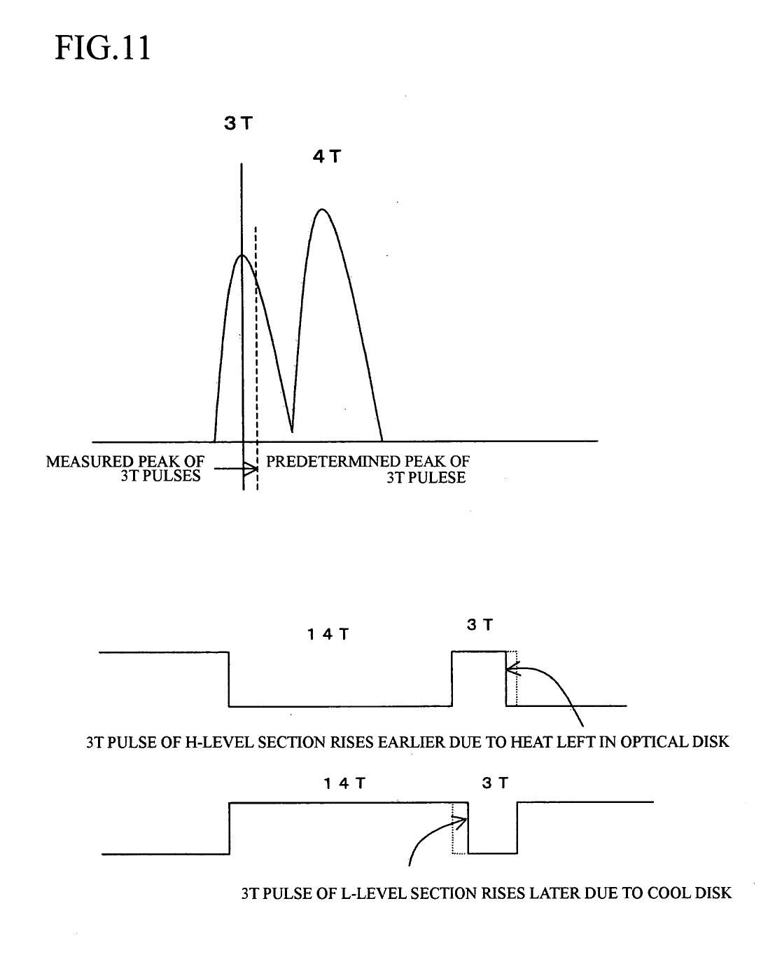

For example, in FIG. 11, a measured peak of 3T pulses is less than a predetermined peak, e.g., about 114 ns. In case that the 3T pulses are the H-level sections, if a long pit, whose length is, for example, 14T, exists immediately before a 3T land, heat remains in the optical disk so that a pit following the 3T land is formed too early. Therefore, the 3T land is made shorter. On the other hand, in case that the 3T pulses are the L-level sections, if a long land, whose length is, for example, 14T, exists immediately before a 3T pit, temperature of the optical disk falls so that the pit is formed too late. Therefore, the 3T pit is made shorter.

The set value adjusting function detects deviations of the peaks of distribution of pulse widths and writes data a plurality of times with revising the peaks in a plurality of stages, so that the set values for writing data, e.g., strategy, laser power, can be adjusted.

Next, detecting widths of distributions of the H- and L-level sections will be explained. Note that, in the present embodiment, the width of distribution means a width at a position corresponding to a half of the peak of distribution.

If a measured width is less than a predetermined value, variation of pulse widths is small. Therefore, the set values, strategy, laser power, need not be varied to revise the width.

On the other hand, if a measured width is greater than the predetermined value, variation of pulse widths is large. Namely, quality of written data is low. Therefore, the set values, strategy, laser power, are varied a plurality of times to make the variation small. Data are written a plurality of times with the varied set values.

There are several methods of evaluating quality of written data with collected data of pulse widths of a binarized RF signal. The evaluating method is not limited to the above described method. For example, the quality may be evaluated by generating a standard clock signal from the binarized RF signal and measuring a deviation of the binarized RF signal with respect to the standard clock signal, i.e., pseudo DD jitter. Further, deviations of the pulse widths of the binarized RF signal with respect to ideal pulse widths thereof may be measured (a deviation method).

In case of using the command for storing optimum set values in the routine work S5, optimum set values for each identification data of optical disks may be stored in the memory means of the optical disk apparatus D. The identification data used by the optical disk apparatus D may be sent from the host computer H as parameters of the command for storing optimum set values or may be read by the reading means 54 of the optical disk apparatus D.

In the routine works S4 and S5, if optimum set values are stored in the memory unit 12 of the host computer H and/or the memory means 49 of the optical disk apparatus D, the optimum set values, which have been stored with the identification data, can be used when data are written in an optical disk, whose identification data have been stored, without measuring and collecting pulse widths of a binarized RF signal. Therefore, working efficiency can be improved.

As shown in FIG. 7, the set value adjusting function of the macro program 30 firstly writes data a plurality of times, e.g., five times, with different laser powers, which are based on the strategies, e.g., first to seventh strategy parameters previously stored in the optical disk W, and analyzes the collected data of binarized RF signals of the five written data so as to determine an optimum laser power (the routine work S21). Then, a plurality of data, e.g., five data, are written with each strategy parameter and with the laser power determined by the routine work S21, and the collected data of the pulse widths of the binarized RF signals of the five written data are analyzed so as to determine optimum strategy parameters (the routine works 22-28). The routine works 22-28 are repeated twice. In the first time, approximate optimum parameters are determined; in the second time, the approximate optimum parameters (optimum combination of the parameters) are further precisely adjusted, so that the strategy parameters can be precisely determined. Then, a further optimum laser power is determined with the optimum strategy parameters (the routine work S29), so that a highly optimum laser power can be determined.

Note that, the algorithm for adjusting the set values is not limited to the above described example.

By employing the host computer H, the optical disk apparatus D and the program C for controlling the optical disk apparatus D, the algorithm for writing test data to determine optimum set values and the algorithm for adjusting set values to determine optimum set values can be performed by the host computer H without executing a firmware of the optical disk apparatus D. Therefore, the highly precise set values for writing data can be determined with further complex algorithms. The collected data can be known by the host computer H, so the collected data can be used by development engineers of the optical disk apparatus D, further a log file including the collected data can be created and effectively used.

In the conventional optical disk apparatus, a firmware must be rewritten to change algorithms. On the other hand, the above described algorithms are written in the macro program 30, so various algorithms can be easily executed by rewriting or updating the macro program without rewriting a firmware.

Further, the set value adjusting function writes data in a user data area. Unlike a conventional OPC (optimum power control) test, write-characteristics of the user data area can be correctly known. Many test data can be written in the user data area, which have a large capacity.

By writing data in the user data area, the optical disk W is wasted. Thus, the optimum set values for each of optical disks W are stored in the parameter areas 70 and 72 in the steps S37 and S48. When data are written in another optical disk W whose identification data are already stored, data can be written with the stored set values without adjusting the set values. Note that, the log file including the identification data may be referred to adjust the set values. In this case, one optical disk is wasted for each of the identification data, the optimum set values for each type of optical disks can be stored. Therefore, the stored optimum set values can be applied to the same types, so that failure rate of writing data in the same type of disks can be lowered. In the conventional optical disk apparatuses, data were miss-written in eight optical disks out of ten. On the other hand, in the present embodiment, only one disk is wasted, but data can be highly precisely written with low failure rate.

When data are written in the optical disk W, if the user may select the optimum set values stored in the memory means 49 or the set values written in the optical disk W, the user can optionally select the set values. The set values can be selected by a parameter of the write-command or a switch of the optical disk apparatus D.

If optimum set values of existing optical disks have been written in a flash ROM of the optical disk apparatus D by a factory as well as the conventional apparatus, preferably the user may select the set values from the stored set values written by the factory, the optimum set values determined by the set value adjusting function, the set values written in the optical disk W, etc.

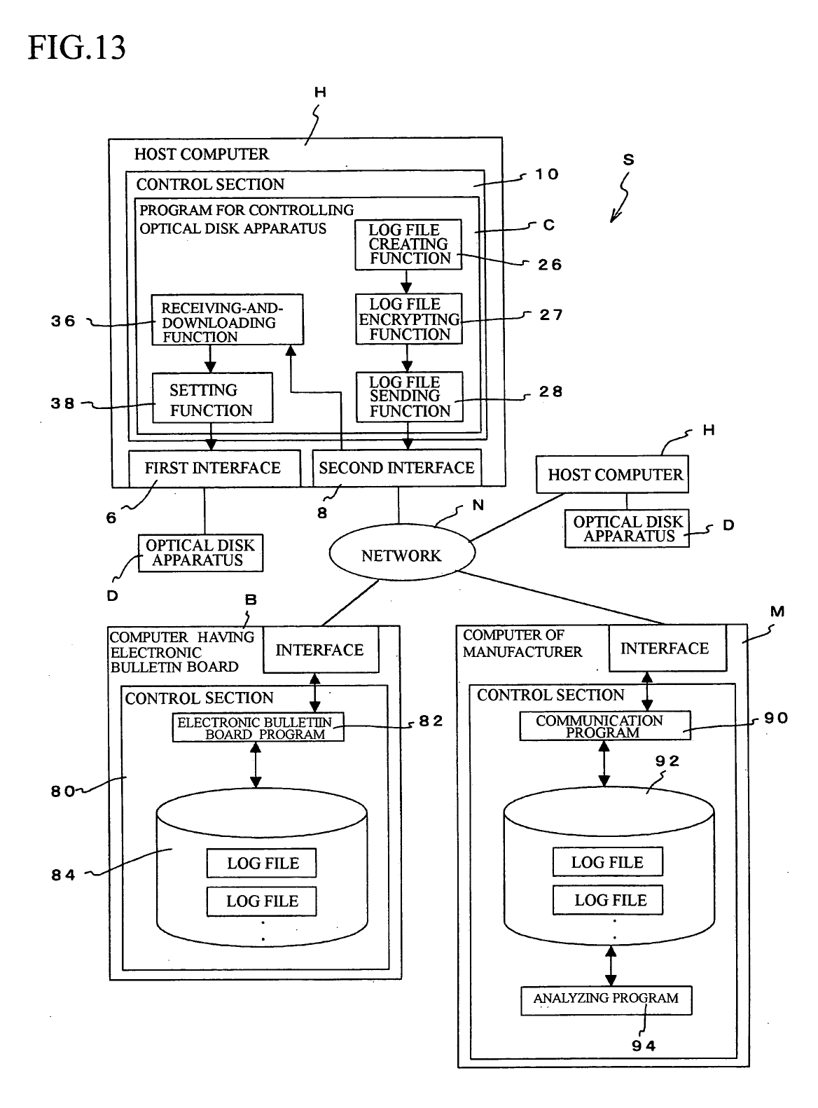

Next, a system S for controlling the optical disk apparatuses D, which includes a plurality of the host computers H, the programs C installed in the host computers H, a plurality of the optical disk apparatuses D which are respectively connected to the host computers H, a computer M of a manufacturer of the optical disk apparatuses D and a computer B having an electronic bulletin board, will be explained with reference to FIG. 13. Note that, structures of the host computers H and the programs C are the same as those of the former embodiment, so some elements described in the former embodiment are omitted from FIG. 13.

Note that, the computer M is a computer owned by the manufacturer, which is operated by employees, etc.

As shown in FIG. 13, the host computers H, the computers M and the computer B of the system S are connected to the network N, e.g., internet.

By executing the program C, a log file encrypting function 27 of each host computer H encrypts the log file, which has been created by a log file creating function 26. A log file transmitting function 28 transmits the log file to the computers M and B via the network N.

The method of transmitting the log file is not limited. For example, the log file may be attached to a known electronic mail.

The log file is encrypted by the log file encrypting function 27 and transmitted. Even if the log file is intercepted by a third party, its contents cannot be known by the third party. Privacy of the user can be protected, and leakage of technology of the optical disk apparatus D can be prevented.

Note that, encrypting and decrypting the log file may be performed by, for example, a public key cryptosystem.

When the computer M receives the log file from the host computer H, a communication program 90 decrypts the log file, and the decrypted log file is stored in memory means 92. Further, a message of receiving the log file is sent to an output unit, e.g., display, so as to inform the message to an engineer, etc. of the manufacturer.

When the engineer of the manufacturer receives the log file, he or she makes the computer M execute a log file analyzing program 94 of analyzing means (not shown). Further, causes of miss-writing can be analyzed, and circumferences of users of the optical disk apparatuses can be known.

Note that, the log file may be automatically analyzed by an automatic analyzing program instead of the program 94.

When the computer M of the manufacturer analyzes records of data quality tests performed by the optical disk apparatus D and determines further optimum set values for writing data on the basis of results of the analysis, the optimum set values are stored in the memory means 92 and sent to the host computer H by the program 90.

This action is performed by the engineer of the manufacturer. In another case, the optimum set values, which have been determined by the program 94, may be automatically sent to the host computer H by the program 90.

In this case too, privacy of the user can be protected and leakage of technology of the optical disk apparatus D can be prevented by encrypting the log file.

The receiving-and-downloading function 36 of the host computer H, which is realized by executing the program C, receives data of the set values sent from the computer M. Then, the setting function 38 sets the received set values in the optical disk apparatus D so as to write data in the optical disk W with the received set values.

With this action, the user of the optical disk apparatus D can receive the optimum set values, which have been gained by analyzing the log file by the engineer of the manufacturer, from the computer M of the manufacturer. Therefore, the user can write data with the optimum set values, which have been analyzed and determined by the manufacturer.

The manufacturer of the optical disk apparatus can analyze causes of miss-writing on the basis of log files sent from the host computers H and can rapidly provide countermeasures. The manufacturer can gain data of circumferences of users, detail data of miss-writing or errors, etc., so that the data can be effectively used for marketing, user support, etc. Further, quality of services can be improved.

If the host computer H is used by the manufacturer of the optical disk apparatus D, the computer, which executed data quality tests, and another computer, which is used by another engineer, can share the log file including results of the data quality tests. By sharing the results, collaborative development can be efficiently performed.

If sending the log file to the computer of the manufacturer by the log file sending function 28 and/or receiving and setting the set values by the receiving-and-downloading function 36 and the setting function 38 are automatically performed without user's operation, data can be written in the optical disk with the optimum set values, which have been automatically set without consciousness of the user.

Next, the computer B having the electronic bulletin board will be explained.

The computer B includes a control section 80 and a bulletin board program 82, which is controlled by the control section 80 so as to realize the electronic bulletin board. Data and information shown on the electronic bulletin board can be referred by computers via the network N. The log file sent from the host computer H is decrypted and stored in memory means 84 and shown on the electronic bulletin board, and external computers can download the log file from the electronic bulletin board via the network N.

The user can optionally write information relating to each log file, e.g., adjustment of set values, impression of writing data, on the electronic bulletin board of the computer B. Further, other users can optionally write messages, etc. on and read them from the electronic bulletin board.

Computers, e.g., the computer M of the manufacturer of the optical disk apparatus, can write information relating to set values for writing data, etc. on the electronic bulletin board of the computer B.

With this structure, information relating to set values for writing data, etc. can be shared between users and the manufacturer. Further, the set values determined on the basis of data quality tests performed by one user can be used by other users. Namely, a virtual community for sharing the information relating to writing data in optical disks can be established.

The log file may include not only the identification data of the optical disk, the set values and the stored data but also a serial number of the optical disk apparatus, offset values for correcting specific variations of the optical disk, e.g., variations of focusing and tracking, accumulated time of using laser means, history of errors, etc. By using the log file, the analysis can be highly precisely performed by the manufacturer, so that the manufacturer can know detail data and information about using conditions of optical disk apparatuses, miss-writing, errors, etc.

When the program 82 shows the log file on the electronic bulletin board, private data included in the log file, e.g., serial number, individual data, should be deleted so as to protect privacies of users.

In the above described embodiments, laser powers and strategies are explained as the set values for writing data. In the present invention, the set values for writing data may further include APC set values, S/H set values, servo set values, other parameters for writing data in optical disks.

In the above described embodiments, the recommended set values are red from the optical disk, but the initial set values corresponding to each type of optical disks, which have been stored in the optical disk apparatus, may be used on the basis of the identification data read from the optical disk (the step S3 of FIG. 5 and the steps S1-14 of FIG. 6).

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

1. A program for controlling an optical disk apparatus, which is read by a host computer connected to the optical disk apparatus so as to write data in an optical disk and which has a function of making the host computer send commands for controlling the optical disk apparatus to the optical disk apparatus,
wherein said command sending function performs the steps of:
sending commands to make the optical disk apparatus read data from the optical disk;
measuring pulse widths of high level sections and low level sections in a plurality of parts of a binarized RF signal of the data;
collecting the pulse widths of the high level sections and number of each pulse width thereof and the pulse widths of the low level sections and number of each pulse width thereof as collected data;
making the optical disk apparatus send the collected data to the host computer; and
making the host computer analyze the collected data so as to perform an adjusting function, which automatically calculates optimum set values for writing data.

2. The program according to claim 1,
wherein said adjusting function performs the steps of:
sending commands to the optical disk apparatus so as to read desired set values for writing data, which have been previously written in the optical disk, or initial set values for writing data, which have been previously stored in the optical disk apparatus;
sending the desired set values or the initial set values to the host computer;
making the host computer, which has received the desired set values or the initial set values, send commands to the optical disk apparatus so as to write data in the optical disk a plurality of times with different set values, which are based on the desired set values or the initial set values;
sending commands to the optical disk apparatus so as to read a plurality of the written data from the optical disk;
measuring pulse widths of high level sections and low level sections in a plurality of parts of a binarized RF signal of the data;
collecting the pulse widths of the high level sections and number of each pulse width thereof and the pulse widths of the low level sections and number of each pulse width thereof for each setting value as collected data;
making the optical disk apparatus send the collected data to the host computer; and
making the host computer select the best quality data from the collected data and determining the set values of the best quality data as optimum set values for writing data.

3. The program according to claim 1,
wherein said program makes the host computer create a log file including: identification data written in optical disks for identifying types of optical disks; the set values for writing data; and the collected data.

4. The program according to claim 2,
wherein said program makes the host computer create a log file including: identification data written in optical disks for identifying types of optical disks; the set values for writing data; and the collected data.

5. The program according to claim 1,
wherein said program makes the host computer send the log file to another computer via a communication line.

6. The program according to claim 2,
wherein said program makes the host computer send the log file to another computer via a communication line.

7. The program according to claim 3,
wherein said program makes the host computer send the log file to another computer via a communication line.

8. The program according to claim 4,
wherein said program makes the host computer send the log file to another computer via a communication line.

9. The program according to claim 5,
wherein said program makes the host computer send the log file to a computer of a manufacturer of the optical disk;
the host computer receives the set values for writing data from the computer of the manufacturer, and
the set values sent from the computer of the manufacturer are used as the set values of the optical disk apparatus for writing data in the optical disk.

10. The program according to claim 6,
wherein said program makes the host computer send the log file to a computer of a manufacturer of the optical disk;
the host computer receives the set values for writing data from the computer of the manufacturer, and
the set values sent from the computer of the manufacturer are used as the set values of the optical disk apparatus for writing data in the optical disk.

11. The program according to claim 7,
wherein said program makes the host computer send the log file to a computer of a manufacturer of the optical disk;
the host computer receives the set values for writing data from the computer of the manufacturer, and
the set values sent from the computer of the manufacturer are used as the set values of the optical disk apparatus for writing data in the optical disk.

12. The program according to claim 8,
wherein said program makes the host computer send the log file to a computer of a manufacturer of the optical disk;
the host computer receives the set values for writing data from the computer of the manufacturer, and
the set values sent from the computer of the manufacturer are used as the set values of the optical disk apparatus for writing data in the optical disk.

13. The program according to claim 5,
wherein said program makes the host computer send the log file to another computer, which has an electronic bulletin board downloadable via a communication line;
wherein said program is capable of downloading the log file placed on the electronic bulletin board, and
the set values included in the downloaded log file are used as the set values of the optical disk apparatus for writing data in the optical disk.

14. The program according to claim 6,
wherein said program makes the host computer send the log file to another computer, which has an electronic bulletin board downloadable via a communication line;
wherein said program is capable of downloading the log file placed on the electronic bulletin board, and
the set values included in the downloaded log file are used as the set values of the optical disk apparatus for writing data in the optical disk.

15. The program according to claim 7,
wherein said program makes the host computer send the log file to another computer, which has an electronic bulletin board downloadable via a communication line;
wherein said program is capable of downloading the log file placed on the electronic bulletin board, and
the set values included in the downloaded log file are used as the set values of the optical disk apparatus for writing data in the optical disk.

16. The program according to claim 8,
wherein said program makes the host computer send the log file to another computer, which has an electronic bulletin board downloadable via a communication line;
wherein said program is capable of downloading the log file placed on the electronic bulletin board, and
the set values included in the downloaded log file are used as the set values of the optical disk apparatus for writing data in the optical disk.

17. The program according to claim 9,
wherein said program makes the host computer send the log file to another computer, which has an electronic bulletin board downloadable via a communication line;
wherein said program is capable of downloading the log file placed on the electronic bulletin board, and
the set values included in the downloaded log file are used as the set values of the optical disk apparatus for writing data in the optical disk.

18. The program according to claim 10,
wherein said program makes the host computer send the log file to another computer, which has an electronic bulletin board downloadable via a communication line;
wherein said program is capable of downloading the log file placed on the electronic bulletin board, and
the set values included in the downloaded log file are used as the set values of the optical disk apparatus for writing data in the optical disk.

19. The program according to claim 11,
wherein said program makes the host computer send the log file to another computer, which has an electronic bulletin board downloadable via a communication line;
wherein said program is capable of downloading the log file placed on the electronic bulletin board, and
the set values included in the downloaded log file are used as the set values of the optical disk apparatus for writing data in the optical disk.

20. The program according to claim 12,
wherein said program makes the host computer send the log file to another computer, which has an electronic bulletin board downloadable via a communication line;
wherein said program is capable of downloading the log file placed on the electronic bulletin board, and
the set values included in the downloaded log file are used as the set values of the optical disk apparatus for writing data in the optical disk.

21. An optical disk apparatus, which is capable of writing data in an optical disk and which can be connected to a host computer, comprising means for analyzing and executing commands sent from the host computer,
wherein said analyzing-and-executing means is capable of analyzing and executing:
a command for setting set values for writing data;
a command for writing data in the optical disk with the set values;
a command for measuring pulse widths of high level sections and low level sections in a plurality of parts of a binarized RF signal of the data;
a command for collecting the pulse widths of the high level sections and number of each pulse width thereof and the pulse widths of the low level sections and number of each pulse width thereof as collected data;
a command for sending the collected data to the host computer;
a command for receiving optimum set values of optical disks from the host computer and storing the optimum set values, which respectively correspond to identification data written in optical disks for identifying types of optical disks, in memory means, and
said writing command reads the optimum set values corresponding to the identification datum of the optical disk from the memory means and writes data in the optical disk with the read optimum set value.
